(19) United States
(12) Patent Application Publication
(10) Pub. No.: US 2009/0268360 A1
(43) Pub. Date: Oct. 29, 2009

(54) PROTECTION CIRCUIT

(75) Inventors: Toshio SHINOMIYA, Ome (JP); Yuji YOKOYAMA, Ome (JP); Akihiro NAGATANI, Higashimurayama (JP); Masato KITA, Higashimurayama (JP)

Correspondence Address: MATTINGLY & MALUR, P.C., 1800 DIAGONAL ROAD, SUITE 370, ALEXANDRIA, VA, 22314, US

(73) Assignee: HITACHI, LTD., Tokyo (JP)

(21) Appl. No.: 12/428,627

(22) Filed: Apr. 23, 2009

(30) Foreign Application Priority Data
Apr. 25, 2008 (JP) 2008-114771

(51) Int. Cl. H02H 9/04

(52) U.S. Cl. 361/56

(57) ABSTRACT

In a protection circuit for protecting semiconductor integrated circuit devices from an electrostatic breakdown or a latch-up due to an external surge, etc, a drain terminal of a PMOS transistor MP1, having a source terminal connected to a power supply VDD and a gate terminal receiving a control signal VG1 which a control circuit 2 generates on the basis of a power supply GND, is connected to one end of a resistor R1, having the other end connected to the power supply GND, and to a gate terminal of an NMOS transistor MN1 having a drain terminal and a source terminal connected to the power supply VDD and the power supply GND, respectively, and outputs an internal signal VG2 to the gate terminal of the NMOS transistor. When a predetermined voltage or more is applied to the power supply, the power supply is short-circuited.

### CLAIM OF PRIORITY

The present application claims priority from Japanese patent application JP2008-114771 filed on Apr. 25, 2008, the content of which is hereby incorporated by reference into this application.

### BACKGROUND OF THE INVENTION

1. Field of the Invention

The present invention relates to a protection circuit that effectively protects a semiconductor integrated circuit device from a latch-up or an electrostatic breakdown due to an external surge, etc.

2. Description of the Related Art

Japanese Patent Laid Open No. S61-264754 is a document relating to a semiconductor integrated circuit device using a CMOS circuit. In particular, FIG. 1 of Japanese Patent Laid Open No. S61-264754 exemplifies a circuit including an NPN-type bipolar transistor having a collector connected to a power supply and an emitter connected to a ground, such that a high value resistor is connected between a base and the emitter and a diode having a breakdown voltage lower than a constituent element of a protected circuit is connected between the base and the collector.

Japanese Patent Laid Open No. 2006-121014 is a document relating to electrostatic protection and a semiconductor integrated device using the same. In particular, FIG. 1 of Japanese Patent Laid Open No. 2006-121014 exemplifies a circuit including a diode having a different forward voltage is connected in series between a trigger terminal of a thyristor, which has an anode A connected to a first terminal P1 and a cathode K connected to a second terminal P2, and the second terminal P2.

### SUMMARY OF THE INVENTION

Inventors of this application and others examined a protection circuit technique for protecting a semiconductor integrated circuit device from a latch-up or an electrostatic breakdown due to an external surge, etc.

Recently, it is difficult to prevent a reduction in a breakdown voltage of a device due to reducing the processes in response to a high degree of integration of semiconductor integrated circuit devices or a reduction in voltage due to an increase in speed or a reduction in power consumption. Moreover, in a semiconductor integrated circuit device having different types of power supply, in which a level of a low voltage input signal received by a low voltage circuit is converted in an internal circuit and a high voltage circuit outputs a high voltage signal, a probability of external surge generation or the like remarkably increases even in the usage environment aspect. Therefore, it is necessary to further consider an electrostatic breakdown or a latch-up.

FIG. 8 shows an example of a general semiconductor integrated circuit device having a protection circuit according to the related art. An internal circuit 8, which is a protected circuit, is connected between a power supply VDD normally having a positive potential and a power supply GND having a ground potential. Moreover, the internal circuit 8 is connected through a protection resistor R2 to an external terminal receiving a control signal I/O. When protection diodes ED2 and ED3 are reversely connected between the external terminal receiving the control signal I/O and the power supply VDD and the power supply GND, the control signal I/O varies beyond a power supply voltage range due to an external surge etc., and a forward bias is applied, the protection diodes are turned on such that current paths to the power supplies are formed. A protection diode ED1 is reversely connected between the power supply VDD and the power supply GND and is turned on when the power VDD falls on the basis of the power GND by a forward voltage of the protection diode ED1 or more, so as to clamp the power VDD. In a protection circuit 7, a capacitor C1 has one end connected to the power supply VDD and the other end connected to one end of a resistor R1 of which the other end is connected to the power supply GND. An NMOS transistor MN1 has a drain terminal and source terminal connected to the power supply VDD and the power supply GND, respectively, and a gate terminal connected to the contact point of the capacitor C1 and the resistor R1 through which an internal signal VG2 is output. When the power VDD rises with respect to the power GND or the power GND falls with respect to the power VDD, on the basis of a time constant determined by the capacitor C1 and the resistor R1, the NMOS transistor is turned on such that the power supply VDD and the power supply GND are short-circuited, thereby suppressing a potential difference from increasing. This AC operation protection circuit 7 which forms a short-circuited path between the power supply VDD and the power supply GND with respect to variation in temporary power is a very important circuit in order to establish a power network. Furthermore, it is necessary to consider that a frequency restriction exists in respects to variation in the power for the protection circuit. In a semiconductor integrated circuit device having different types of power supplies in which both of a high voltage and a low voltage are used, a surge in a high voltage may be easily introduced to a low voltage circuit but surge voltages or response waveforms are various, not one type as defined in a surge test specification. One example may include a Load-Dump test used for an apparatus for vehicle installation. In other words, in the AC operation protection circuit 7 for which a time constant of several hundreds nanoseconds is generally set, it is considered that a DC operation protection circuit effective with respect to an external surge due to power variation in a very delayed frequency range is necessary. Moreover, since the AC operation protection circuit 7 operates depending on the speed of a response in respects to variation in power, the NMOS transistor MN1 may continue to short-circuit the power supplies by the conditions of the protection operation so as to excessively fall the voltage between the power supplies.

FIG. 9 shows a basic configuration shown in FIG. 1 of Japanese Patent Laid Open No. S61-264754 as an example of a general DC operation protection circuit. A zener diode DZ1 has a cathode terminal connected to a power supply VDD and an anode connected to one end of a resistor R1 of which the other end is connected to a power supply GND. An internal signal VG2 is output from the contact point of the zener diode DZ1 and the resistor R1. The contact point also is connected to a source terminal of an NPN transistor QN1 having a collector terminal and an emitter terminal connected to the power supply VDD and the power supply GND, respectively. Here, a breakdown voltage of the zener diode DZ1 is designed to have a value lower than that of a device constituting a protected circuit. Therefore, when power VDD rises due to, for example, an external surge, the zener diode DZ1 breaks down before an electrostatic breakdown or a latch-up occurs due to a breakdown of the protected circuit, thereby increasing the internal signal VG2 and turning on the NPN transistor QN1. Accordingly, the power supply VDD and the power supply GND are short-circuited so as to suppress a potential difference from increasing. This DC operation protection circuit has a small circuit size and is functional, but it has a drawback in that the protection operation threshold voltage thereof is uniquely determined at the breakdown voltage of the zener diode DZ1. For example, a shipping inspection requires a burn-in test in a high-temperature environment be performed on a semiconductor integrated circuit device, an arbitrary bias higher than a normal operation power supply voltage is applied to perform an accelerated test. Therefore, it is required to set the operation threshold voltage of the protection circuit to an arbitrary voltage higher than the power supply voltage applied during the burn-in test. A zener diode can be easily formed in a general CMOS process. However, in order to adjust the breakdown voltage thereof, a photomask or a manufacturing process for adjusting voltage amount is added, which results in an increase in manufacturing cost. For this reason, a technique capable of adjusting a threshold voltage of a DC operation protection circuit in a semiconductor integrated circuit has been found.

According to a representative embodiment of the invention, a protection circuit includes: a first power supply terminal receiving a first potential in a first state; a second power supply terminal receiving a second potential lower than the first potential in the first state; a first current shunt part including a PMOS transistor and a first resistor, the PMOS transistor performing current level sensing to detect the magnitude of current flowing between source and drain terminals when a predetermined reference potential is applied to a gate terminal thereof, the first resistor being connected to the drain terminal of the PMOS transistor and the second power supply terminal, and when a transition is made from the first state to a second state in which a third potential higher than the first potential is applied to the first power supply terminal connected to the source terminal of the PMOS transistor, the first current shunt part performing a first current shunt to convert an increase in the current between the source and drain terminals of the PMOS transistor, corresponding to a rise in the potential from the first potential to the third potential, into a voltage signal by the first resistor, and to output the voltage signal as a power supply voltage rise level signal; and a second current shunt part including an NMOS transistor having a drain terminal electrically connected to the first power supply terminal, a source terminal electrically connected to the second power supply terminal, and a gate terminal connected to the drain terminal of the PMOS transistor, and performing a second current shunt to pull a current out of the first power supply terminal in response to the power supply voltage rise level signal applied to the gate terminal of the NMOS transistor.

A drain terminal of the NMOS transistor may be electrically connected to the first power supply terminal through a second resistor. In this case, the second resistor may include diodes forwardly cascaded in one or more stages.

Similarly, the first resistor may include diodes forwardly cascaded in one or more stages. Moreover, the second resistor includes at least one diode forwardly cascaded in one or more stages.

According to another aspect of the present invention, a protection circuit includes: an NMOS transistor having a drain terminal connected to a first power supply and a source terminal connected to a second power supply normally having a potential lower than the first power supply; a control circuit supplying a control signal normally having a predetermined potential higher than the first power supply on the basis of the second power supply; a PMOS transistor having a source terminal to the first power supply, and a gate terminal connected to the second control signal on the basis of the second power supply, and a resistor having one end connected to the first power supply and the other end connected to a gate terminal of the NMOS transistor and a drain terminal of the PMOS transistor, thereby controlling a potential difference between the first power supply and the second power supply due to an external surge etc., not to exceed a predetermined voltage.

The PMOS transistor and the NMOS transistor can be appropriately substituted with a PNP-type bipolar transistor and an NPN-type transistor, respectively, and such a substituted configuration is within the scope of the invention.

According to the invention, it is possible to suppress the voltage between power supplies from becoming a predetermined voltage or more due to disturbances such as an external surge, thereby protecting the internal circuit from an electrostatic breakdown or a latch-up.

### BRIEF DESCRIPTION OF THE DRAWINGS

FIG. 1 is a diagram illustrating a protection circuit according to a first embodiment of the invention;

FIG. 2 is a diagram illustrating a protection circuit according to a second embodiment of the invention;

FIG. 3 is a diagram illustrating a protection circuit according to a third embodiment of the invention;

FIG. 4 is a diagram illustrating a first example of a control circuit supplying a control signal VG1 of FIG. 1;

FIG. 5 is a timing chart illustrating an operation of FIG. 4;

FIG. 6 is a diagram illustrating a protection circuit according to a fourth embodiment of the invention;

FIG. 7 is a diagram illustrating a protection circuit according to a fifth embodiment of the invention;

FIG. 8 is a diagram illustrating an example of a semiconductor integrated circuit device having a protection circuit according to the related art; and

FIG. 9 is a diagram illustrating a second example of an operation protection circuit 7 shown in FIG. 8 according to the related art.

### DETAILED DESCRIPTION OF THE PREFERRED EMBODIMENTS

A protection circuit according to some embodiments of the invention includes a first power supply terminal, a second power supply terminal, a first current shunt part, and a second current shunt part.

The first power supply terminal is a terminal to which a first potential is supplied in a first state. The second power supply terminal is a terminal to which a second potential lower than the first potential is supplied in the first state.

The first current shunt part includes a PMOS transistor and a first resistor. The PMOS transistor performs current level sensing to detect the magnitude of current flowing between source and drain terminals when a predetermined reference potential is applied to a gate terminal thereof, and the first resistor is connected between the drain terminal of the PMOS transistor and the second power supply terminal. When a transition is made from the first state to a second state in which a third potential higher than the first potential is applied to the first power supply terminal connected to the source terminal of the PMOS transistor, the first current shunt part performs a first current shunt to convert an increase in the current between the source and drain terminals of the PMOS transistor, corresponding to a rise in the potential from the first potential to the third potential, into a voltage signal by the first resistor, and to output the voltage signal as a power supply voltage rise level signal.

The second current shunt part includes an NMOS transistor having a drain terminal electrically connected to the first power supply terminal, a source terminal electrically connected to the second power supply terminal, and a gate terminal connected to the drain terminal of the PMOS transistor. The second current shunt part performs a second current shunt to pull a current out of the first power supply terminal in response to the power supply voltage rise level signal applied to the gate terminal of the NMOS transistor.

The drain terminal of the NMOS transistor may be electrically connected to the first power supply terminal through a second resistor. In this case, the second resistor may include diodes forwardly connected in series in one or more stages.

Similarly, the first resistor may include diodes forwardly connected in series in one or more stages. Furthermore, the second resistor may include one or more diodes forwardly connected in series in one or more stages.

Hereinafter, embodiments of the invention will be described in detail with reference to the accompanying drawings. Circuit elements constituting blocks of each of the embodiments are formed on one semiconductor substrate such as a monocrystalline silicon substrate by a known integrated circuit technique such as a CMOS (Complementary MOS) transistor technique, unless specifically defined. A circuit symbol of a MOSFET (Metal Oxide Semiconductor Field Effect Transistor) without an arrow represents an N-type MOSFET (NMOS), and is distinguished from a circuit symbol of a P-type MOSFET (PMOS) with an arrow. Hereinafter, a MOSFET is briefly referred to as a MOS. However, the embodiments of the invention are not limited to Field Effect Transistors including oxide-film insulating films provided between metal gates and semiconductor layers, but are applicable to circuits using general FETs such as MISFET (Metal Insulator Semiconductor Field Effect Transistor).

### First Embodiment

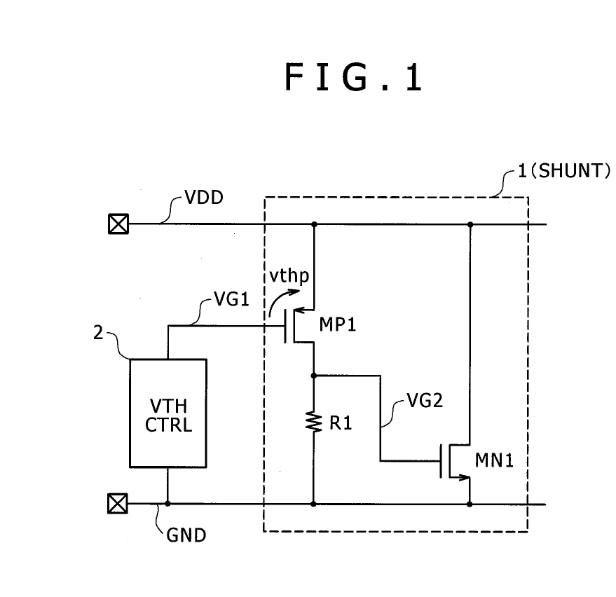

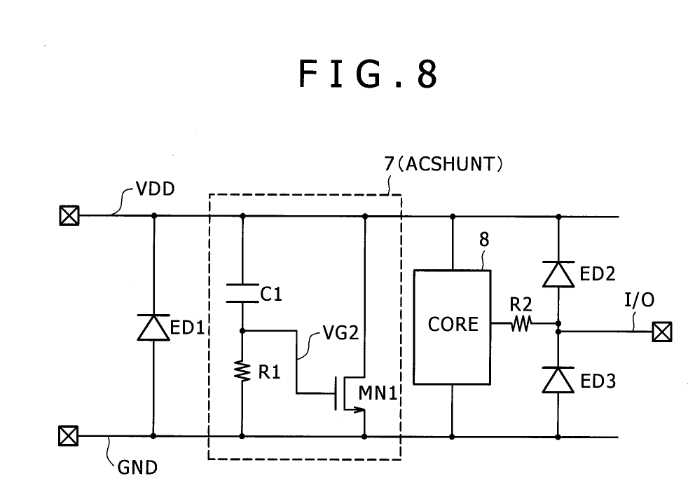

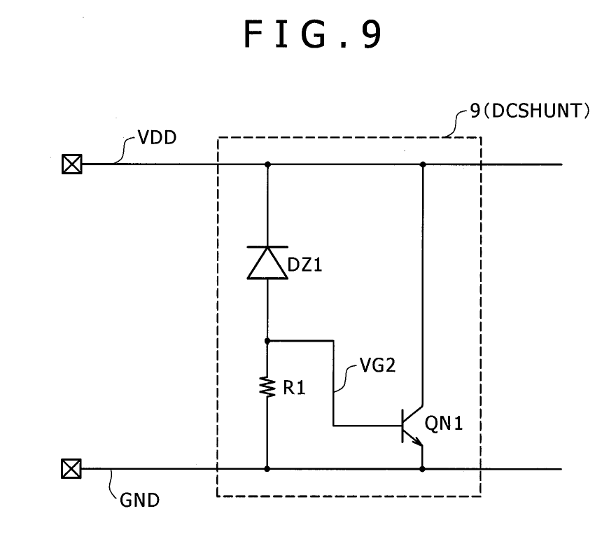

FIG. 1 is a diagram illustrating a protection circuit according to a first embodiment of the invention. A PMOS transistor MP1 has a source terminal connected to a power supply VDD and a gate terminal receiving a control signal VG1 generated by a control circuit 2 on the basis of a power supply GND, and serves as a sensing circuit for sensing a potential difference between the power supply VDD and the power supply GND. When VDD−GND≧VG1+vthp, in which vthp denotes a threshold voltage of the PMOS transistor MP1, is established, the PMOS transistor MP1 is turned on and thus a current flows to the resistor R1 so as to increase the internal signal VG2 which was at a power GND level. Accordingly, an NMOS transistor MN1 having a drain terminal and a source terminal connected to the power supply VDD and the power supply GND, respectively, and a gate terminal receiving the internal signal VG2 is turned on so as to short-circuit the power supply VDD and the power supply GND. Therefore, when, for example, power VDD charges up due to, for example, an external surge, so as to have a higher potential, as long as the above-mentioned conditional expression is satisfied, charge-up charge of the power VDD is transferred to power GND, whereby the potential of the power VDD is suppressed from rising so as to protect an internal circuit (not shown) from latch-up or an electrostatic breakdown. This is similarly applied to a case in which the power GND falls. Also, when the NMOS transistor MN1 is turned on to fall the voltage between the power supplies such that a transition is made from the abnormal state in which the above-mentioned condition expression is satisfied to a normal state (VDD-GND<VG1+vthp), the PMOS transistor MP1 sensing the voltage between the power supplies is turned off to turn off the NMOS transistor MN1 short-circuiting between the power supplies. Therefore, the voltage between the power supplies does not excessively fall, unlike the example according to the related art described with reference to FIG. 8.

### Second Embodiment

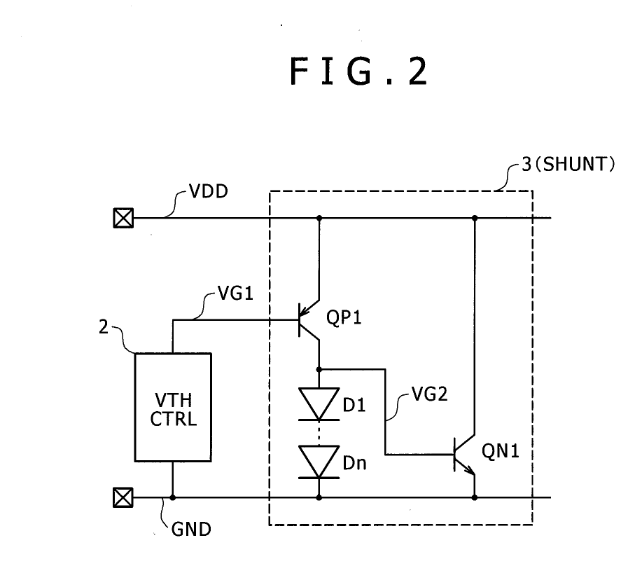

FIG. 2 is a diagram illustrating a protection circuit according to a second embodiment of the invention. A basic configuration and a basic operation are the same as those of the first embodiment of FIG. 1 and thus a description thereof is omitted. Different functional parts will be described. When a PNP transistor is prepared, the PMOS transistor MP1 of FIG. 1 can be substituted with the PNP transistor. Further, when an NPN transistor is prepared, the NMOS transistor MN1 can be substituted with an NPN transistor. Similarly, the resistor R1 can be substituted with forward diodes Dn cascaded in multiple stages, a resistor connected in series with a forward diode, or a resistor using an ON resistance of a MOS transistor. Such substitution may be applied to any one of the devices according to the characteristics or circuit operations of the devices.

### Third Embodiment

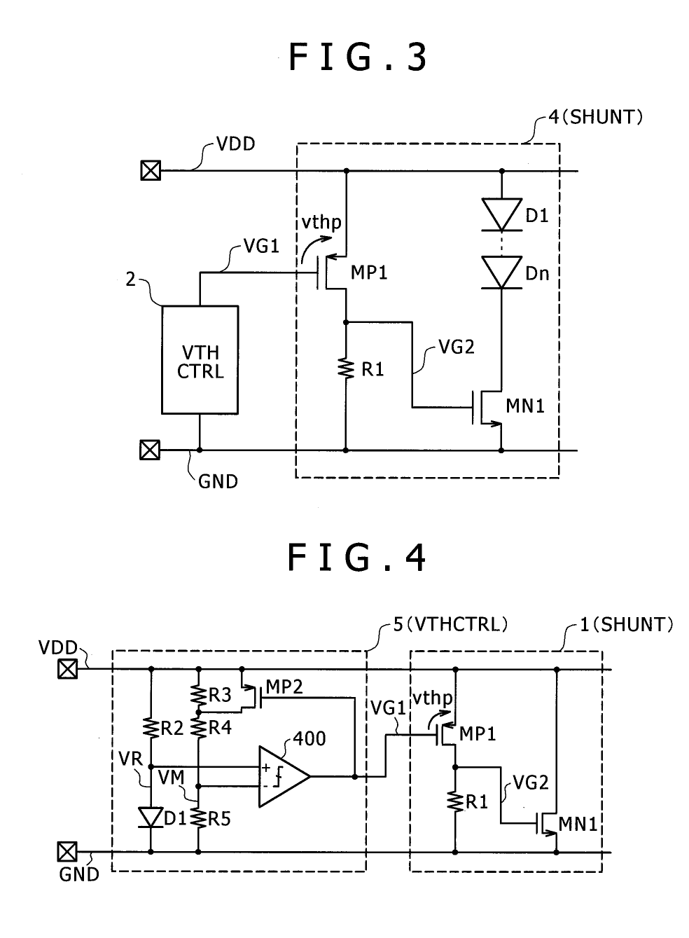

FIG. 3 is a diagram illustrating a protection circuit according to a third embodiment of the invention. A basic configuration and a basic operation are the same as those of the first embodiment of FIG. 1 and thus a description thereof is omitted. Different functional parts will be described. In FIG. 1, the drain terminal of the NMOS transistor MN1 is connected to the power supply VDD. However, in the third embodiment, forward diodes Dn cascaded in multiple stages are provided between the power supply VDD and the drain terminal. The stage number of the diodes Dn is adjusted such that the sum of forward voltages thereof becomes a value approximate to the potential difference between the power supply VDD and the power supply GND during a normal operation. Therefore, even when turning off of the NMOS transistor MN1 is delayed, the voltage between the power supplies is clamped around a normal operation voltage by the diodes Dn, whereby the voltage between the power supplies is prevented from excessively falling.

### Fourth Embodiment

FIG. 4 is a diagram illustrating a first example of a control circuit 2 outputting a control signal VG1 normally higher than the power VDD on the basis of the power GND shown in the first embodiment of FIG. 1. For easy understanding of an operation scheme, a protection circuit 1 is shown. However, since the operation of the protection circuit has been described in the first embodiment, a description thereof is omitted. A control circuit 5 compares a reference voltage VR based on the power GND with a power monitor voltage VM depending on the voltage between the power supplies, inverts the output VG1 of a comparator 400 from the power VDD to the power GND when the voltage between the power supplies exceeds a threshold, and controls the protection circuit 1 to operate. The reference voltage VR is generated by a potential of an end of a resistor R2 of which the other end is connected to the power supply VDD and a potential of an anode of a diode D1 of which a cathode is connected to the power supply GND. Meanwhile, a resistor R3, a resistor R4, and a resistor R5 are connected in series between the power supply VDD and the power supply GND, and the power monitor voltage VM depending on the voltage between the power supplies is obtained from a potential of a contact point of the resistor R4 and the resistor R5. A PMOS transistor MP2 is connected in parallel to the resistor R3 and receives the output VG1 of the comparator 400 through a gate terminal thereof provided in order to make the output VG1 of the comparator 400 to have hysteresis.

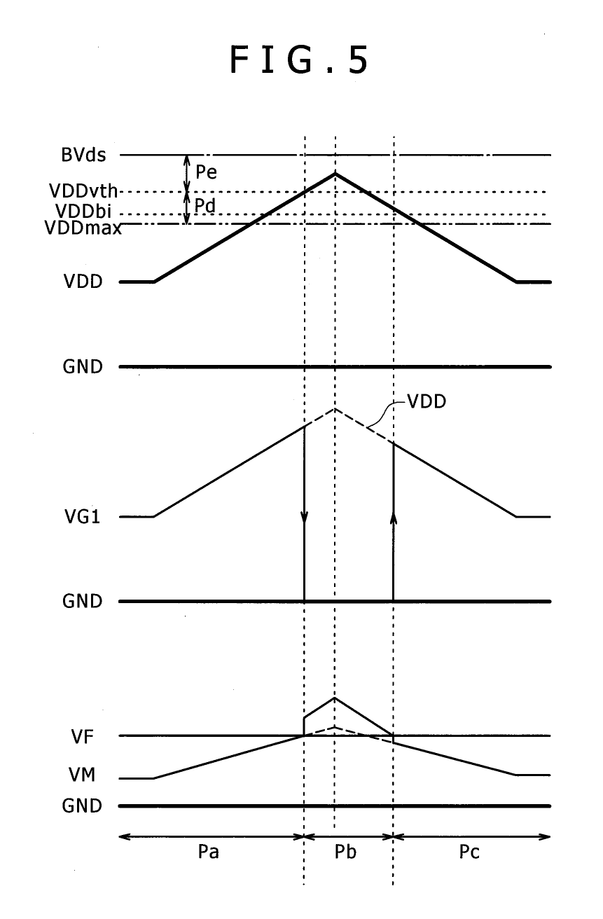

FIG. 5 is a timing chart illustrating an operation of the control circuit 5 shown in FIG. 4 when the power VDD increases due to an external surge, etc.

A period Pa is a period in which the power VDD increases due to a surge, etc. The power monitor voltage VM also correspondingly increases with the increase of the power VDD. Since the relationship between power supply VDD and the reference voltage VR satisfies VR>VM and thus the output VG1 of the comparator has the value of the power VDD, the protection circuit 1 is in a non-operation state. Then, when the power VDD rises beyond a threshold power supply voltage VDDvth such that a relationship of VR<VM is established, the output VG1 of the comparator is inverted from the power VDD to the power GND, and the protection circuit 1 operates. Moreover, the PMOS transistor MP2 to which the output VG1 is fed back is turned on such that the power monitor voltage VM rises to have hysteresis so as to prevent the chattering of the power, etc. The value of the reference voltage VR determining the threshold power supply voltage VDDvth is set to be higher than a maximum operation voltage VDDmax of the power VDD or an operation voltage VDDbi of a burn-in test performed in a shipping inspection and lower than the minimum breakdown voltage of devices constituting a protected circuit.

A period Pb is a period in which, if the power monitor voltage VM obtained by dividing the power VDD by use of the resistors is beyond the reference voltage VR determined from the power GND, the comparator operates to have hysteresis at a threshold, and then the control voltage VG1 controlling the protection circuit is inverted from the power VDD to the power GND. This is a procedure in which the protection circuit 1 is operated to apply charge introduced by, for example, an external surge increasing the power VDD, to the power supply GND, thereby dropping the power VDD. Then, when the power VDD falls such that the relationship of VR>VM is established, the output VG1 of the comparator is transitioned from the power GND to the power VDD to have hysteresis and thus the protection circuit 1 is turned off.

A period Pc is a period in which, if the power VDD falls such that the power monitor voltage VM is below the threshold, the comparator operates to have hysteresis at a threshold, and then the control voltage VG1 controlling the protection circuit is inverted from the power GND to the power VDD. This is a condition after the power VDD falls such that the protection circuit 1 enters a non-operation state.

Here, a value (d) is a threshold margin voltage, on which the comparator operates, with respect to a maximum operation power supply voltage VDDmax, and a value (e) is a threshold margin voltage, on which the comparator operates, with respect to the breakdown voltage BVds of a protected device.

### Fifth Embodiment

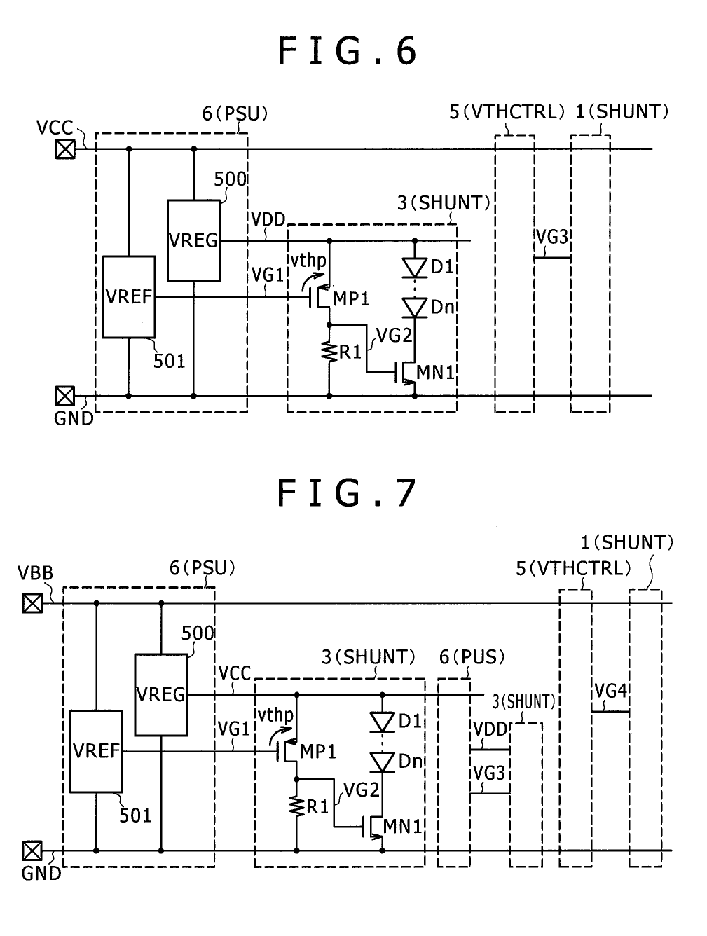

FIG. 6 is a diagram illustrating a protection circuit according to a fourth embodiment of the invention, including a second example of the control circuit 2 normally outputting the control signal VG1 higher than the power VDD on the basis of the power GND according to the first embodiment shown in FIG. 1. A reference power supply voltage circuit 6 which receives the power VCC and the power GND to operate includes an internal power generating circuit 500 and a reference voltage circuit 501. The internal power generating circuit 500 supplies internal power VDD to an internal circuit (not shown) operating on a voltage lower than the power VCC, and the reference voltage circuit 501 generates a reference voltage. A protection circuit according to claims 1 to 3 is applied for the internal power VDD. When a protection circuit 3 is required to operate using an internal power supply voltage VDDvth as the threshold value with respect to the power GND in order to protect the internal circuit operating on the internal power VDD, a voltage VDDvth-vthp (in which vthp denotes a threshold voltage of a PMOS transistor MP1) may be applied to a gate terminal of the PMOS transistor MP1. For example, if the power VCC is external power of 35V and the internal power VDD is 3V, even though it is considered that a breakdown voltage of a 3V device operating on the internal power VDD is 7V to 9V, the reference voltage circuit 501 using the power of 35V of the power supply VCC can easily generate a voltage of VDDvth-vthp based on the power GND. A simple example of the generation method is to connect diodes D1 in series in N-number of stages and to obtain a voltage which is N times a forward activation voltage of a diode, similar to the reference voltage VR based on the power GND described with reference to FIG. 4. The same configuration as that in FIG. 4 is disposed between the power supply VCC and the power supply GND for protecting the internal circuit (not shown) connected to the power supply VCC.

### Sixth Embodiment

FIG. 7 is a diagram illustrating a protection circuit according to a fifth embodiment of the invention. A basic configuration and a basic operation are the same as those of the fourth embodiment of FIG. 6 and thus a description thereof is omitted. Different functional parts will be described. In the fifth embodiment, a dual internal power supply configuration in which a pair of the configuration according to the fourth embodiment is provided between power VBB and internal power VCC generated on the basis of the power VBB and another pair of the configuration according to the fourth embodiment is provided between the internal power VCC and another internal power VDD generated on the basis of the internal power VCC is applied. Even when three or more internal power supplies are used, a similar construction may be applied, thereby obtaining effects of the embodiments of the invention.

What is claimed is:

1. A protection circuit, comprising:
a first power supply terminal receiving a first potential in a first state;
a second power supply terminal receiving a second potential lower than the first potential in the first state;
a first current shunt part including a PMOS transistor and a first resistor, the PMOS transistor performing current level sensing to detect the magnitude of current flowing between source and drain terminals when a predetermined reference potential is applied to a gate terminal thereof, the first resistor being connected between the drain terminal of the PMOS transistor and the second power supply terminal, and when a transition is made from the first state to a second state in which a third potential higher than the first potential is applied to the first power supply terminal connected to the source terminal of the PMOS transistor, the first current shunt part performing a first current shunt to convert an increase in the current between the source and drain terminals of the PMOS transistor, corresponding to a rise in the potential from the first potential to the third potential, into a voltage signal by the first resistor, and to output the voltage signal as a power supply voltage rise level signal; and
a second current shunt part including an NMOS transistor having a drain terminal electrically connected to the first power supply terminal, a source terminal electrically connected to the second power supply terminal, and a gate terminal connected to the drain terminal of the PMOS transistor, and performing a second current shunt to pull a current out of the first power supply terminal in response to the power supply voltage rise level signal applied to the gate terminal of the NMOS transistor.

2. The protection circuit according to claim 1,
wherein a drain terminal of the NMOS transistor is electrically connected to the first power supply terminal through a second resistor.

3. The protection circuit according to claim 2,
wherein the second resistor includes diodes forwardly cascaded in one or more stages.

4. The protection circuit according to claim 1,
wherein the first resistor includes diodes forwardly cascaded in one or more stages.

5. The protection circuit according to claim 4,
wherein the second resistor includes diodes forwardly cascaded in one or more stages.

6. A protection circuit, comprising:
an NMOS transistor having a drain terminal connected to a first power supply and a source terminal connected to a second power supply normally having a potential lower than the first power supply;
a control circuit supplying a control signal normally having a predetermined potential higher than the first power supply on the basis of the second power supply;
a PMOS transistor having a source terminal connected to the first power supply, and a gate terminal connected to the control signal on the basis of the second power supply; and
a resistor having one end connected to the second power supply and the other end connected to a gate terminal of the NMOS transistor and a drain terminal of the PMOS transistor,
wherein a potential difference between the first power supply and the second power supply due to disturbances including an external surge is suppressed from exceeding a predetermined voltage.

7. The protection circuit according to claim 6,
wherein diodes are provided to be forwardly cascaded in series in a predetermined number of stages between the drain terminal of the NMOS transistor and the first power supply.

8. The protection circuit according to claim 6,
wherein the control circuit supplying the control signal normally having a predetermined potential higher than the first power supply compares a reference voltage based on the second power supply and a monitor potential sensing a potential difference between the first power supply and the second power supply, and
wherein, in case that the potential difference between the first power supply and the second power supply is beyond a predetermined potential, the control circuit controls the gate terminal of the PMOS transistor below a threshold voltage turning on the PMOS transistor.

9. The protection circuit according to claim 6, further comprising:
a third power supply supplying a gate terminal potential tuning on the PMOS transistor when the potential difference between the first power supply and the second power supply is beyond the predetermined potential,
wherein the control signal normally having a predetermined potential higher than the first power supply is generated by using the third power supply on the basis of the second power supply.

10. The protection circuit according to claim 9, further comprising:
a second NMOS transistor having a drain terminal connected to the third power supply, and a source terminal connected to the second power supply normally having a potential lower than the third power supply;
a second control circuit supplying a second control signal normally having a predetermined potential higher than the third power supply on the basis of the second power supply;
a second PMOS transistor having a source terminal connected to the third power supply, and a gate terminal connected to the second control signal on the basis of the second power supply; and
a second resistor having one end connected to the second power supply and the other end connected to a gate terminal of the second NMOS transistor and a drain terminal of the second PMOS transistor,
wherein a potential difference between the third power supply and the second power supply due to disturbance including an external surge is suppressed from exceeding a predetermined voltage.

11. The protection circuit according to claim 10, further comprising:
a fourth power supply supplying a gate terminal potential tuning on the second PMOS transistor when the potential difference between the third power supply and the second power supply is more than the predetermined potential,
wherein the second control signal normally having a predetermined potential higher than the third power supply is generated by using the fourth power supply on the basis of the second power supply.

12. The protection circuit according to claim 11, further comprising:
a third NMOS transistor having a drain terminal connected to the fourth power supply, and a source terminal connected to the second power supply normally having a potential lower than the fourth power supply;
a third control circuit supplying a third control signal normally having a predetermined potential higher than the fourth power supply on the basis of the second power supply;
a third PMOS transistor having a source terminal connected to the fourth power supply, and a gate terminal connected to the second control signal on the basis of the second power supply; and
a third resistor having one end connected to the second power supply and the other end connected to a gate terminal of the third NMOS transistor and a drain terminal of the third PMOS transistor,
wherein a potential difference between the fourth power supply and the second power supply due to disturbances including an external surge is suppressed from exceeding a predetermined voltage.

13. A protection circuit, comprising:
a first power supply terminal receiving a first potential in a first state;
a second power supply terminal receiving a second potential lower than the first potential in the first state;
a first current shunt part including a PNP bipolar transistor and a first resistor, the PNP bipolar transistor performing current level sensing to detect the magnitude of current flowing between emitter and collector terminals when a predetermined reference potential is applied to a base terminal thereof, the first resistor being connected to the collector terminal of the PNP bipolar transistor and the second power supply terminal, and when a transition is made from the first state to a second state in which a third potential higher than the first potential is applied to the first power supply terminal connected to the emitter terminal of the PNP bipolar transistor, the first current shunt part performing a first current shunt to convert an increase in the current between the emitter and collector terminals of the PNP bipolar transistor, corresponding to a rise in the potential from the first potential to the third potential, into a voltage signal by the first resistor, and to output the voltage signal as a power supply voltage rise level signal; and
a second current shunt part including an NPN bipolar transistor having a collector terminal electrically connected to the first power supply terminal, an emitter terminal electrically connected to the second power supply terminal, and a base terminal connected to the collector terminal of the PNP bipolar transistor, and performing a second current shunt to pull a current out of the first power supply terminal in response to the power supply voltage rise level signal applied to the base terminal of the NPN bipolar transistor.

14. The protection circuit according to claim 13,
wherein a collector terminal of the NPN bipolar transistor is electrically connected to the first power supply terminal through a second resistor.

15. The protection circuit according to claim 14,
wherein the second resistor includes diodes forwardly cascaded in one or more stages.

16. The protection circuit according to claim 13,
wherein the first resistor includes diodes forwardly cascaded in one or more stages.

17. The protection circuit according to claim 16,
wherein the second resistor includes diodes forwardly cascaded in one or more stages.
